(19) United States
(12) Patent Application Publication
(10) Pub. No.: US 2020/0079680 A1
(43) Pub. Date: Mar. 12, 2020

(54) Technique For Fabricating A Multistructure Core Rod Used In Formation Of Hollow Core Optical Fibers

(71) Applicant: OFS Fitel, LLC, Norcross, GA (US)

(72) Inventors: Matt Corrado, Flemington, NJ (US); David J DiGiovanni, Mountain Lakes, NJ (US); Brian Mangan, Hopewell, NJ (US); Gabriel Puc, Lebanon, NJ (US); Robert S Windeler, Annandale, NJ (US); Tristan Kremp, Somerset, NJ (US)

(73) Assignee: OFS Fitel, LLC, Norcross, GA (US)

(21) Appl. No.: 16/128,951

(22) Filed: Sep. 12, 2018

(51) Int. Cl. C03B 37/027; G02B 6/032; G02B 6/02

(52) U.S. Cl. CPC C03B 37/02781; G02B 6/032; C03B 2205/10; C03B 2203/16; G02B 6/02328

(57) ABSTRACT

A process of fabricating the microstructure core rod preform used in the fabrication of a hollow core optical fiber includes the step of applying external pressure to selected hollow regions during the drawing of the preform from the initial assembly of capillary tubes. The application of pressure assists the selected hollow regions in maintaining their shape as much as possible during draw, and reduces distortions in the microstructure cells in close proximity to the core by controlling glass distribution during MCR draw.

### TECHNICAL FIELD

The present invention relates to the fabrication of hollow core optical fibers and, more particularly, to a method of making a microstructure core rod (MCR) that controls glass distribution during MCR formation.

### BACKGROUND OF THE INVENTION

Hollow core optical fibers allow guidance of light almost entirely in a vacuum, or in a liquid or gas filling the hollow core. This capability opens up several possibilities, such as achieving extremely low optical non-linearities in a potentially low-loss, bend-resistant optical fiber. The unique properties of the hollow core fiber are potentially useful in a number of different applications, including optical transmission, sensing, pulse compression, and the like.

A hollow core optical fiber based on photonic bandgap principles comprises a cladding region that is formed by a matrix of glass-air cells, with a hollow core region formed as a centrally-located “gap” within the matrix of cells. That is, the core gap spans a plurality of cells and has a boundary (core wall) defined by the interface between the core gap and the cells of the cladding. The cells are typically of hexagonal topology, forming a photonic bandgap structure that confines propagation of an optical signal to the hollow core region (it is to be noted that several of the cells immediately adjacent to the core region are pentagonal, not hexagonal, in form).

The vertices of an individual cell are defined as “nodes”, with the span connecting two adjacent nodes defined as a “strut”. The spacing between nodes of an exemplary cell, the thickness of the struts, and in particular the relative cross-sectional areas of the struts and nodes immediately adjacent to the core wall, are critical to obtaining optimal optical properties in the final, drawn fiber. These features are determined by the properties of the MCR from which the fiber is drawn, as well as the conditions of the fiber draw process itself. The node spacing and strut thickness of the MCR is, in turn, determined by the properties of the various capillary tubes assembled to create the MCR, as well as the MCR draw conditions. It follows, therefore, that the relative areas of the struts and nodes in the final hollow core optical fiber are determined by the fiber draw conditions, as well as the strut and node properties of the MCR. At each step, there are distortions and deviations of the glass distribution from the ideal design.

A hollow core optical fiber based on anti-resonance principles comprises a cladding region that is formed by a ring of cladding tubes or other such anti-resonant features (which may or may not be round and may or may not contact each other) disposed around an outer periphery of the cladding region (i.e., disposed immediately inside an outer cladding tube used to form the assembly). The “core region” is thus the hollow area in the central region of the configuration, surrounded by the cladding tubes. In this anti-resonant (AR) configuration, the spacing between the tubes and the wall thickness of the tubes themselves need to be carefully controlled to confine light to the inner (core) hollow region. As with the photonic bandgap design, distortions and deviations in the glass distribution during the formation of an MCR for AR hollow core fibers have been found to degrade the performance of the final drawn fiber, particularly in terms of the resonances that are established or forbidden.

More broadly, in any design of an optical fiber that includes gas-filled regions, slight distortions and deviations from the ideal design of the preform (e.g., MCR in the case of microstructured fibers) can quickly degrade the optical properties of the drawn fiber since the refractive index contrast between gas (e.g., air) and glass is so high.

A method is needed, therefore, to improve the control of glass distribution during fabrication of an MCR/preform so that the optical properties of the final drawn fiber are not impacted by distortions in the glass structure.

### SUMMARY OF THE INVENTION

The need remaining in the prior art is addressed by the present invention, which relates to the fabrication of hollow core optical fibers and, more particularly, to a method of making a microstructure core rod (MCR) that controls glass distribution during MCR formation.

In accordance with the principles of the present invention, an external pressure is applied to selected hollow tubes within the assembly during the process of creating an MCR from the initial collection of capillary tubes. The selected hollow tubes may be, for example, a core tube, shunt tubes, and/or one or more strategically-located capillary tubes, when forming a photonic bandgap MCR. When forming an anti-resonant MCR, the selected hollow tubes may be, for example, one or more cladding tubes or the interior hollow region defining the core itself. The pressurization of the selected hollow tubes works against the collapse of these tubes, controlling the glass distribution during the process of forming the MCR such that distortions in the final MCR structure is reduced. The magnitude of the applied pressure is a factor in determining the amount of distortion that is mitigated.

It is an advantage of the technique of the present invention that by virtue of controlling the process of forming an MCR, the subsequent process of drawing down the MCR into the final fiber structure does not require special process steps; that is, the final glass structure created in the MCR will carry over into the fiber configuration. Indeed, when the MCR is drawn down into a fiber, an exemplary prior art process of sealing the top of the MCR and drawing the fiber while providing self-pressurization in all of the holes can be used.

One embodiment of the present invention related to fabricating a microstructure core rod by fabricating a starting preform using the stack-and-draw method with constituent components required of the design, including relevant cladding materials, core tube, shunts and other design modifications. After this, the process continues by drawing down the preform into MCRs of the desired size using the addition of external pressure to modify the glass distribution.

An exemplary embodiment of the present invention takes the form of a method for fabricating a microstructure core rod comprising the steps of: arranging a plurality of capillary tubes in a matrix of a preform assembly and drawing the preform assembly into the microstructure core rod by heating and collapsing the plurality of capillary tubes to fuse together, wherein during the drawing step, performing the step of applying an external pressure to one or more selected hollow regions in the preform assembly sufficient to control glass distribution among the fusing capillary tubes.

Other and further advantages and embodiments of the present invention will become apparent during the course of the following discussion and by reference to the accompanying drawings.

### BRIEF DESCRIPTION OF THE DRAWINGS

Referring now to the drawings,

FIG. 1 is a cross-sectional view of a prior art microstructure core rod (MCR) used in the fabrication of a hollow core optical fiber;

FIG. 2 is a simplified cross-sectional diagram of an alternative prior art MCR, in this case formed to include a pair of shut regions for controlling the propagating of unwanted modes in the central core region;

FIG. 3 is an enlarged view of a portion of FIG. 2, illustrating the location of the nodes and struts around the perimeter of the core region (the “keystone” region that most impacts the optical properties of the drawn fiber);

FIG. 4 is a micrograph of a prior art MCR, showing the distortion in the keystone cells resulting in “pinching” the cells located between the core and shunts;

FIG. 5 is a micrograph of a prior art hollow core optical fiber drawn from the MCR shown in FIG. 4, showing that the distortion in the MCR is not cured during the fiber draw process;

FIG. 6 is a simplified diagram of an exemplary draw apparatus formed in accordance with the present invention to apply an external pressure to the core region of the assembly of capillary tubes during the process of drawing the MCR from the assembly;

FIG. 7 is a micrograph of an exemplary MCR formed in accordance with the present invention, where a pressure of 5 torr was applied to the core region during MCR draw;

FIG. 8 is a micrograph of another exemplary MCR formed in accordance with the present invention, in this case where a pressure of 10 torr was applied to the core region during MCR draw; and

FIG. 9 illustrates an exemplary anti-resonant MCR, which comprises a ring of cladding tubes disposed around the inner periphery of an overcladding layer.

### DETAILED DESCRIPTION

The inventive process of providing external pressure to selected hollow areas within an assembly of capillary tubes used to form an MCR is applicable to the formation of both photonic bandgap MCRs and anti-resonant MCRs. For the sake of clarity, each type of MCR will be discussed in turn below. However, it needs to be understood that the scope of the invention is not limited to one type or other and, indeed, the application of an external pressure to a hollow region of an assembly being processed into an optical preform in its most general sense is considered to fall within the scope of the present invention.

Photonic Bandgap MCR Formation

A conventional hollow core photonic optical fiber comprises a hollow core region surrounded by a microstructured cladding formed of a matrix of individual glass-air cells. Such fibers may be manufactured, for example, using a “stack-and-draw” technique, in which a plurality of capillary tubes, fabricated from silica glass, are suitably arranged to create a preform assembly. The preform assembly typically includes an outer tube of like material for holding together the plurality of capillary tubes. The preform assembly is heated and slightly drawn down to fuse together the capillary tubes and remove interstitial spaces between the tubes. The drawn structure at this point is typically referred to as the “microstructure core rod” (MCR). Following this process, the MCR is itself inserted into a glass tube (e.g., overcladding tube) and this configuration is then drawn down into the final form of the hollow core optical fiber.

As mentioned above, the spacing between nodes of a hollow core photonic bandgap optical fiber, as well as the thickness of the struts between the nodes (particularly the relative areas of the struts and nodes in close proximity to the hollow core region) are critical to obtaining the desired optical properties (e.g., low loss, control of wavelength range supported by hollow core region, etc.). The application of heat during the draw process causes the glass to flow and thus while this flow (in combination with the draw tension) achieves the desired reduction in size, the actual distribution of glass within the structure is not well controlled.

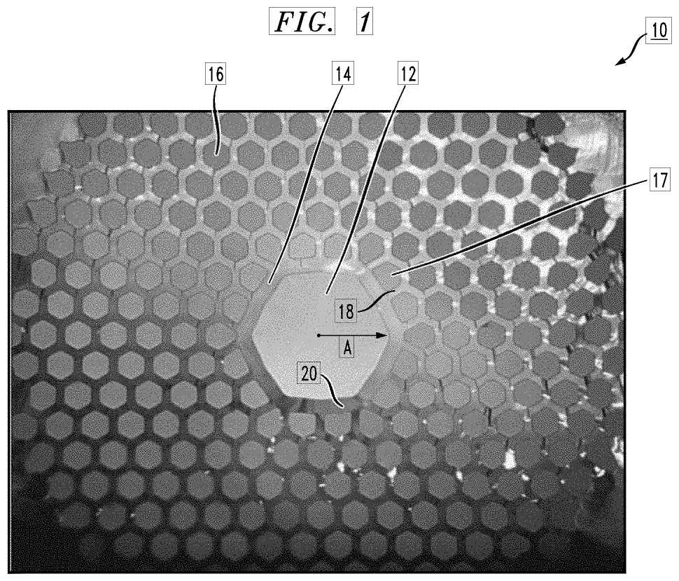

FIG. 1 is a cross-sectional view of an exemplary prior art MCR 10, showing a hollow core region 12 surrounded by a core tube 14, the core tube forming the “wall”, or interface, between the core and cladding. Prior art MCR 10 is shown as also comprising a set of hexagonal cells 16 forming a majority of the matrix structure of the cladding region surrounding hollow core region 12. The matrix structure also includes a set of pentagonal cells 17 adjacent to core tube 14, as shown in FIG. 1. As will be discussed in detail below, hexagonal cells 16 immediately adjacent to core region 12 have the most impact on the optical properties of the fiber drawn from the MCR. In particular, the physical properties of nodes 18 where the cells contact core region 12 and the struts 20 impact the properties of the drawn fiber. Hollow core region 12 is defined as having a “5 pitch” size, meaning that a set of five capillary rods was removed along its central axis A to achieve the desired diameter for this particular configuration (other cladding pitch sizes are obviously possible and are used in other situations). This definition of cladding pitch will be referred to hereinbelow when describing the improvement in glass distribution and reduction in cladding deformations around the core region associated with the principles of the present invention.

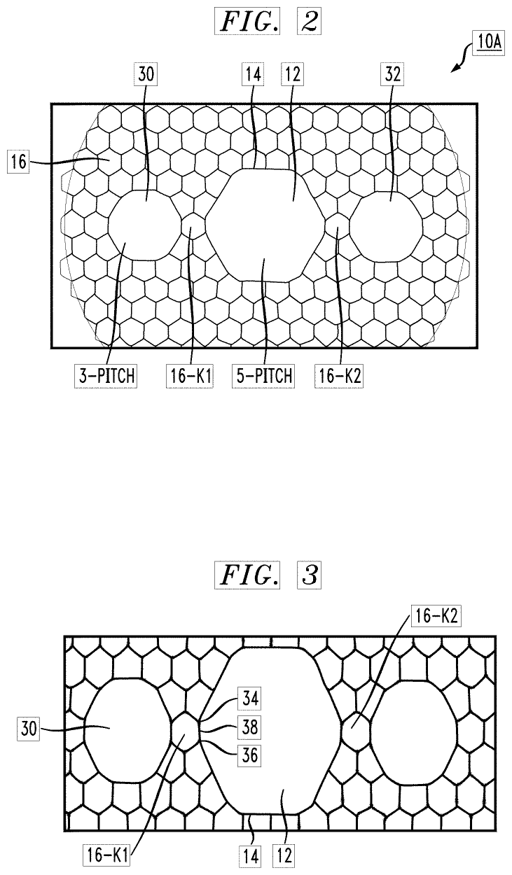

In some cases, the MCR is formed to include one or more shunts, which are additional hollow regions spaced apart from the core and used to suppress the propagation of higher-order modes within the central core region. FIG. 2 is a cross-sectional view of an idealized MCR 10A, similar to that of FIG. 1 but in this case further comprising a pair of spaced-apart shunt regions 30, 32 disposed on either side of hollow core region 12. Similar to the configuration of FIG. 1, MCR 10A exhibits a 5-pitch core diameter. Here, each shunt region 30 and 32 is formed as a “3-pitch” structure.

In this embodiment, the physical parameters of the cells between core region 12 and shunts 30, 32 (hereinafter referred to as the “keystone” region) is of the most critical concern to acceptable performance of the hollow core fiber ultimately drawn from this MCR. In this particular embodiment, the keystone region includes a first keystone cell 16-k1 positioned between core region 12 and shunt 30, and a second keystone cell 16-k2 disposed between core region 12 and shunt 32. For the sake of explanation of terms used herein, FIG. 3 is an enlarged view of a portion of the arrangement of FIG. 2. Referring to both FIGS. 2 and 3, first keystone cell 16-k1 is defined as including a pair of nodes 34, 36 that contact core region 12, and a strut 38 that extends between nodes 34 and 36. The spacing between nodes 34, 36 as well as the thickness of strut 38, are factors that influence the optical properties of the drawn hollow core optical fiber. A similar arrangement of nodes and struts is formed with respect to second keystone cell 16-k2 as positioned between core region 12 and shunt 32.

With this understanding of the configuration of a conventional prior art photonic bandgap MCR and the importance of the nodes, struts and keystone cells, a brief overview of a conventional process of drawing an MCR is provided, so as to enable a better understanding of the details of the present invention.

As mentioned above, a typical photonic bandgap MCR is formed by heating and drawing an assembled collection of separate capillary tubes into a microstructured “rod” where the capillary tubes are fused together. The holes within the capillaries tend to collapse during draw due to surface tension, but this is counter-acted by internal pressure within the holes. A simple way to establish the pressure necessary to balance surface tension is to seal the far end termination of each tube that ultimately forms the core, shunts, and cladding holes of the hollow core fiber. As described in U.S. Pat. No. 5,802,234 issued on Sep. 1, 1998 and assigned to the assignee of this application, the act of sealing the ends of these regions results in partial self-pressurization during the draw process, which produces uniform and consistent tube properties.

As the MCR is drawn from the initial assembly, there is some gas flow through the bottom of the MCR. Since the flow resistance of a tube decreases nonlinearly (greater than unity) with respect to its cross-sectional area, the gas flow is greater for the core region than for the smaller capillary tubes used to form the microstructured cladding region. This is true even in relative terms when compared to the reduction of the remaining air volume in the yet-to-be-drawn portion of the assembly. Additionally, if shunt regions are included in the assembly, the gas flow through these holes will be somewhat less than the core, but greater than the capillary tubes of the cladding. Therefore, the core and shunt tubes collapse slightly more than the surrounding cladding tubes. As a result, the core (and shunts, if present) are undersized in the finished MCR, causing the keystone nodes to be brought closer together than they would be in an undistorted structure.

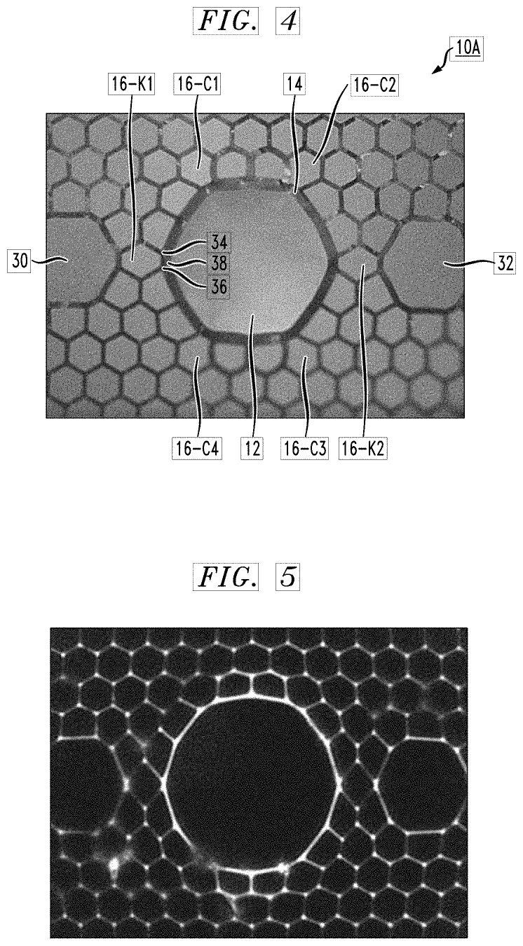

FIG. 4 is a microscopic image of a finished prior art MCR 10A, which clearly illustrates the distortion in keystone cells 16-k1, 16-k2. As shown, the slightly undersized shunts and core cause cells 16-k1, 16-k2 to extend horizontally (i.e., along the x-axis as shown in FIG. 4) and contract vertically (i.e., along the y-axis). Nodes 34 and 36 of keystone cell 16-k1 are shown as being relatively close together (somewhat “pinched” in form), as a result of glass distortions during MCR fabrication (in particular, the reduction in size of the core and shunt regions). The movement of nodes 34, 36 closer to each other also results in strut 38 becoming shorter and thicker. Obviously, the same changes occur for the keystone nodes and strut along the opposing side of core 12, associated with second keystone cell 16-k2.

These changes in the thickness of the struts and nodes during MCR formation have been found to significantly impact the properties of the drawn optical fiber. Besides distortions in specific keystone cells 16-k1 and 16-k2, the properties of the drawn fiber are also impacted by the distortions created in a set of “corner” capillary cells surrounding the core region, shown as corner cells 16-c1, 16-c2, 16-c3, and 16-c4 in FIG. 4. These other distortions, in terms of node spacing, strut length and strut thickness, are also evident in the image of FIG. 4. As one moves further out and away from the core region, the cladding cells take on a more regular geometry and are not considered to impact the properties of the drawn fiber.

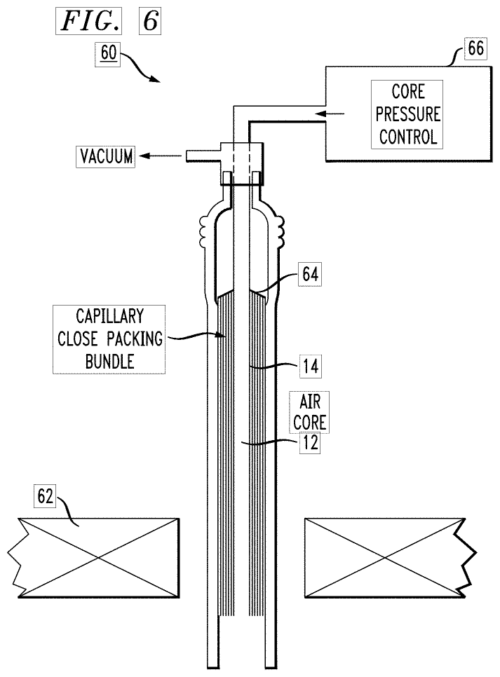

It has also been found that the subsequent fiber draw process cannot cure (or reverse) the distorted form of these cells, particularly with respect to the keystone cells surrounding the core region. FIG. 5 is a micrograph of a hollow core optical fiber drawn from the MCR shown in FIG. 4. The retention of the distorted keystone nodes is evident in the configuration of the final fiber, even though the core region has been somewhat enlarged.

To achieve acceptable optical properties (e.g., low loss), the spacing of the nodes and the relative areas of the struts and nodes should be more uniform along the core wall (that is, around the circumference of the hollow core region). This goal is desirable for optical fibers having only a central hollow core region, as well as photonic bandgap fibers having multiple shunt regions disposed around the hollow core region.

These problems are addressed by the present invention, which in this exemplary embodiment relates to a modification in the process of forming a photonic bandgap MCR so that the core region maintains its shape as much as possible, which has been found to reduce the distortions created in the keystone cells during MCR draw. In particular, the present invention proposes the application of external pressure to selected hollow regions during MCR draw, the external pressure working against the natural collapse of these regions otherwise present in the MCR draw process and controlling glass distribution during the process of forming the MCR.

A simplified diagram of an exemplary draw apparatus 60 used in accordance with one or more embodiments of the present invention to draw an MCR rod from an initial assembly of capillary tubes is shown in FIG. 6. Similar to prior art configurations, the collection of capillary rods and canes used to form a photonic bandgap MCR 100 is introduced into a furnace 62 that functions to heat a portion of the assembly, fusing together the capillaries. A vacuum force can be used to collapse the interstitial areas between the outermost capillaries and the surrounding overcladding tube. Preferably, end terminations 64 of the capillaries (except for those to be subjected to external pressurization) are sealed prior to initiating MCR draw, to allow for self-pressurization to take place in these areas and maintain the desired openings.

In accordance with this embodiment of the present invention, an external source 66 is used to inject a gas into selected hollow regions, such as core region 12 (i.e., “pressurizing” central core region 12). In this case, the pressurization functions to maintain a positive pressure within core region 12 as the surrounding capillaries fuse together to form the microstructured cladding region (i.e., the matrix of cells). The added pressure controls glass distribution and causes the core to slightly expand (or at least resist collapsing). By minimizing the possibility of reduction in core size, the keystone nodes do not substantially move any closer together, and the strut between these keystone nodes essentially maintains its original (relative) length and thickness. The achieved separation between the nodes is not only measured as an absolute value, but also a relative amount in terms of comparing the separations to other nodes. Thus, the node spacing and the relative area of the struts and nodes along the core wall become more uniform, which minimize distortions in the cell structure and typically improves the optical properties of a fiber drawn from this type of photonic bandgap MCR.

In one exemplary embodiment of the present invention, the addition of a pressure on the order of about 5 torr to core region 12 results in slightly expanding the diameter of core region 12, thus maintaining nodes 34, 36 in a spaced-apart relationship. A micrograph of an MCR formed with an applied core pressure of 5 torr during MCR draw is shown in FIG. 7, where in this case the final core diameter is a value that is 103% of the initial 5-pitch size defined above. Said another way, the application of a pressure in hollow core region 12 may be controlled in accordance with the present invention to provide a desired ratio between the final core diameter and the initial cladding pitch-defined diameter (such as, for example, the 5-pitch diameter). In comparing this MCR to the distorted prior art structure shown in FIG. 4, the difference in shape of keystone cells 16-k1 and 16-k2 is clear. That is, the addition of pressure in accordance with the principles of the present invention is shown as preventing nodes 34, 36 from moving together and “pinching” keystone cells 16-k. The difference in length and width of strut 38 is also evident when comparing the distorted prior art MCR of FIG. 4 to the improved MCR of the present invention, as shown in FIG. 7.

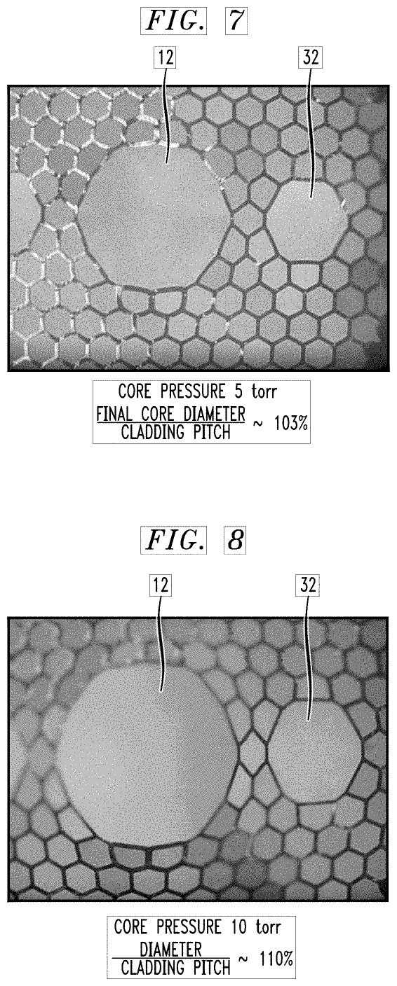

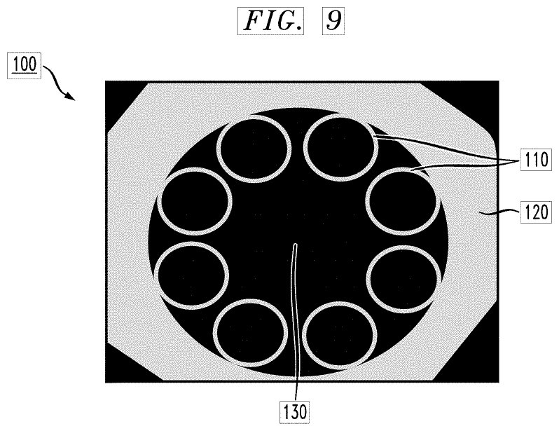

FIG. 8 is a micrograph of another MCR formed in accordance with the present invention, in this case maintaining a pressure of about 10 torr within the core region during MCR draw. In comparing the structures of FIGS. 7 and 8, increasing the core pressure from 5 torr to 10 torr expands the core region by an additional amount (here, to a value about 114% of the original 5-pitch structure), resulting in further lengthening strut 38. Applying the inventive process of core pressurization during MCR draw is shown to maintain a separation between the core nodes, which also results in maintaining a strut of sufficient length (and desired thickness) between these nodes.

In an alternative configuration of this photonic bandgap embodiment of the present invention, if the photonic bandgap MCR is to be formed to include a set of shunts, the inventive method may be configured to also provide an external pressure to one or more of the shunt regions during MCR draw. Indeed, it is considered that the ability to introduce an external pressure to both the core and shunt regions will result in a MCR structure with less keystone cell distortion than if only the core region (or only the shunt regions) are subjected to pressurization. Further, the application of an external pressure to selected corner capillaries (see FIG. 4) is also beneficial in terms of minimizing distortions in the final structure of the photonic bandgap MCR.

A slightly over-expanded core may even produce better optical properties for certain designs. Therefore, expanding the core during MCR by the application of pressure in accordance with one or more embodiments of the present invention may also be used to produce optimized node spacing and wall thickness for selected optical properties. Indeed, it is contemplated that the use of core/shunt pressurization during MCR formation in accordance with the present invention can be used to optimize node spacing during MCR draw. It then follows that the core and shunt sizes can be optimized during the subsequent process of drawing the hollow core fiber from the MCR. For example, certain distortions occur to the core region during fiber draw (e.g., rounding of the core). By pre-distorting the position of the nodes during MCR formation, the final fiber (with the rounded core) may be made with less overall distortion. Thus, the use of core pressurization during MCR fabrication in accordance with the present invention serves to de-couple the physical properties of the nodes and struts from the final size (diameter) of the core and shunts.

Inasmuch as changes in pressure within the core region are applied externally during MCR formation, the specific pressure values can be adjusted during the draw of multiple MCRs from a single assembly of starting material. In an exemplary fabrication process, the MCR core size becomes stable by about the fourth or fifth MCR drawn from the starting material. If the core size measured at this point is outside of the desired range, the pressure applied within the core can be adjusted (in either direction, as needed) to bring the core size back within the specified limits. As a result, the initial set of MCRs with an “out-of-spec” core will not be further processed, saving fabrication costs by not continuing to draw fiber from these MCRs.

Separating the difficult task of achieving the correct core size and desired supported wavelength, which are typically both addressed during fiber draw, into two separate mechanisms in accordance with the principles of the present invention is considered to simplify the overall fabrication process while also significantly increasing the yield of hollow core optical fiber that meets system specifications. Said another way, when the optimized core size is achieved during draw of the MCRs, the fiber can be drawn with a simpler and more repeatable method, such as self-pressurization.

Anti-Resonant MCR Formation

FIG. 9 illustrates an exemplary anti-resonant MCR 100, which comprises a ring of cladding tubes 110 disposed around the inner periphery of an overcladding layer 120. A key property of an anti-resonant hollow core fiber is that it exhibits a sequence of narrow-bandwidth high-loss regions where the core modes become resonant (i.e., phase matched) with the cladding modes. In between these high-loss regions, the core modes are anti-resonant with respect to the cladding modes, which provides for confinement of these modes within an air-filled core 130. As mentioned above, the spacing between adjacent cladding tubes 110 (including the case where adjacent tubes contact each other), the cross-sectional shape of the tubes (round, oval, etc.) and the thickness of the cladding tube walls, all impact the resonant/anti-resonant conditions established within the fiber.

In accordance with one exemplary configuration of this embodiment of the present invention, therefore, the application of an external pressure to one or more of the cladding tubes 110 works against their natural tendency to collapse during MCR draw. The ability to control glass distribution between the cladding tubes by providing the external pressurization therefore provides a means of achieve the desired resonant and anti-resonant core modes. Indeed, similar to the above-described capability of enlarging the hollow core region, the size of the cladding tubes in an anti-resonant MCR can be controlled by adjusting the level of the externally applied pressure. The amount of applied external pressure also serves to control the thickness of the walls of the cladding tubes and controlling the spacing between adjacent tubes. In some configurations, it is preferred that adjacent tubes do not contact one another. The application of an external pressure may facilitate this result. In situations where it is desired to intentionally introduce an asymmetry among the cladding tubes, it is possible to apply an external pressure to only selected ones of the tubes.

In another configuration, it is possible to pressurize the hollow inner region forming the core area 130 of an anti-resonant MCR. When performing this type of control, it is preferred that the cladding tubes be sealed so that they will self-pressurize during MCR draw and not distort.

While the foregoing description includes details that will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended thereto and that the claims be interpreted as broadly as permitted by the prior art in light of the language of the specification.

What is claimed is:

1. A method for fabricating a microstructure core rod comprising the steps of
arranging a plurality of capillary tubes in a matrix of a preform assembly;
drawing the preform assembly into the microstructure core rod by heating and collapsing the plurality of capillary tubes to fuse together, wherein during the drawing step, performing the step of
applying an external pressure to one or more selected hollow regions in the preform assembly sufficient to control glass distribution among the fusing capillary tubes.

2. The method as defined in claim 1 wherein the preform assembly is arranged as a photonic bandgap assembly by
removing a plurality of centrally-located capillary tubes to define a hollow core region of a predetermined size, defined as an N-pitch cladding diameter, where N is the number of capillary tubes removed across a central axis of the assembly; and
inserting a core tube within the hollow core region.

3. The method as defined in claim 2 wherein the external pressure is applied to a hollow core region and controlled to create a core size of a predetermined ratio of final diameter to original N-pitch cladding diameter.

4. The method as defined in claim 2 wherein the selected hollow regions comprise a set of cells surrounding and contacting the hollow core region, each cell defined by a pair of nodes contacting the core tube and a strut extending between the pair of nodes.

5. The method as defined in claim 4 wherein the external pressure is applied to the hollow core region and controlled to minimize differences in strut length around the core tube in the drawn microstructure core rod.

6. The method as defined in claim 4 wherein the applied external pressure is controlled to maintain a separation between the pair of nodes, reducing the tendency of the nodes to coalesce and pinch the shape of the associated cell.

7. The method as defined in claim 4 wherein the applied external pressure is controlled to maintain a separation between the pair of nodes, thereby maintaining a strut of a desired length and thickness.

8. The method as defined in claim 2, wherein the step of applying an external pressure includes applying an additional external pressure to one or more additional capillary tubes surrounding the core region.

9. The method as defined in claim 2, wherein the photonic bandgap assembly further comprises one or more hollow shunt regions.

10. The method as defined in claim 9, wherein the step of applying an external pressure includes applying an additional external pressure to at least one of the one or more hollow shunt regions.

11. The method as defined in claim 2, wherein prior to beginning the drawing step, the capillaries not selected to receive external pressure are sealed shut to create self-pressurization during the drawing step.

12. The method as defined in claim 1, wherein the preform assembly is arranged as an anti-resonant preform assembly.

13. The method as defined in claim 12, wherein the external pressure is applied to one or more cladding tubes in the anti-resonant preform assembly.

14. The method as defined in claim 12, wherein the external pressure is applied to an interior core region.

15. The method as defined in claim 4, wherein the external pressure is applied to optimize spacing between adjacent nodes, and subsequent to the step of drawing the preform assembly step, the method further comprises the step of
controlling a process of drawing a hollow core fiber from the preform assembly to create a desired core diameter.

16. The method as defined in claim 15 wherein the step of controlling a process includes the step of sealing open end terminations of the preform assembly prior to drawing the hollow core fiber from the preform assembly.
